(19) United States
(12) Patent Application Publication
(10) Pub. No.: US 2016/0284502 A1
(43) Pub. Date: Sep. 29, 2016

(54) WAVEGUIDE

(71) Applicant: LANCASTER UNIVERSITY BUSINESS ENTERPRISES LTD, Lancaster, Lancashire (GB)

(72) Inventor: Claudio PAOLONI, Lancaster (GB)

(21) Appl. No.: 15/034,040

(22) PCT Filed: Nov. 4, 2014
(86) PCT No.: PCT/GB2014/053270

§ 371 Date: May 3, 2016

(30) Foreign Application Priority Data
Nov. 4, 2013 (GB) 1319438.6

(51) Int. Cl. H01J 25/36

(52) U.S. Cl. CPC H01J 25/36

(57) ABSTRACT

The present invention is a rectangular waveguide (100) providing amplification of an electromagnetic wave via interaction with an electron beam (107) in a channel defined by two parallel rows of alternately provided substantially identical pillars ((109), (111)). The pillars are attached to the base (113) of the waveguide, with a void between the top of each pillar and the roof (103) of the waveguide.

There is a need for a device able to operate as an amplifier or oscillator at gigahertz and terahertz frequencies with good gain and output power, whose physical design makes it straightforward to manufacture, disassemble and reassemble.

The present invention provides these features by a novel physical and electrical waveguide configuration, comprising interaction of an electromagnetic wave with an electron beam via two rows of alternately offset free-standing pillars. Embodiments act as an amplifier or oscillator in the frequency band from 10 to 2,000 gigahertz.

Currently solid-state devices are able to provide only about 10 milliwatts of output power in the 200 to 300 GHz band. Travelling wave tubes (“TWT”) still remain the preferred solution to generate high power over a wide spectrum in this frequency band.

Folded waveguides, staggered double grating waveguides and sine waveguides have all been demonstrated in terahertz TWTs, with cylindrical or sheet electron beams in the 100 to 850 GHz frequency range. Such waveguides have to be fabricated in two (or more) precision parts with the sealing edge critical to confinement of the propagating electromagnetic field. A very high precision assembly process is required (to eliminate misalignments that could perturb the wave propagation). New structures are desired with simpler assembly in order to lower the costs and improve repeatability and reliability.

Mineo & Paoloni (IEEE Transactions on electron devices, Vol. 57, no. 11, 3169, November 2010) propose a rectangular double-corrugated waveguide (“DCW”) slow-wave structure for terahertz vacuum devices. That device comprises two rows of free-standing pillars arranged as transverse pairs, whereas the present invention achieves superior performance with two rows of alternately provided free-standing pillars.

The present invention improves over the DCW in a number of significant areas, including gain, output power, ease of manufacture and ease of vacuum pumping.

The present invention is a rectangular waveguide providing amplification of an electromagnetic wave via interaction with an electron beam in a channel, where: the channel is confined above and below by the waveguide, the channel is defined laterally by two parallel rows of alternately provided substantially identical pillars, the said pillars are attached substantially perpendicularly to the base of the waveguide, and there is a void between the top of each pillar and the roof of the waveguide.

According to one aspect of the present invention, the waveguide comprises the features provided herein.

According to a further aspect of the present invention, the waveguide consists essentially of the features provided herein.

The top of the waveguide may be attached to complete manufacture and subsequently detached and re-attached.

The pillars may be formed with no attachment to the walls of the waveguide.

The device may operate in the 10 GHz to 2,000 GHz band, in the 100 GHz to 1,000 GHz band, the 200 GHz to 650 GHz band, and/or the 200 GHz to 250 GHz band.

The pillars may be in cross-section substantially square, rectangular, circular, elliptical or triangular.

The components of the device may be made in metal and/or coated in metal.

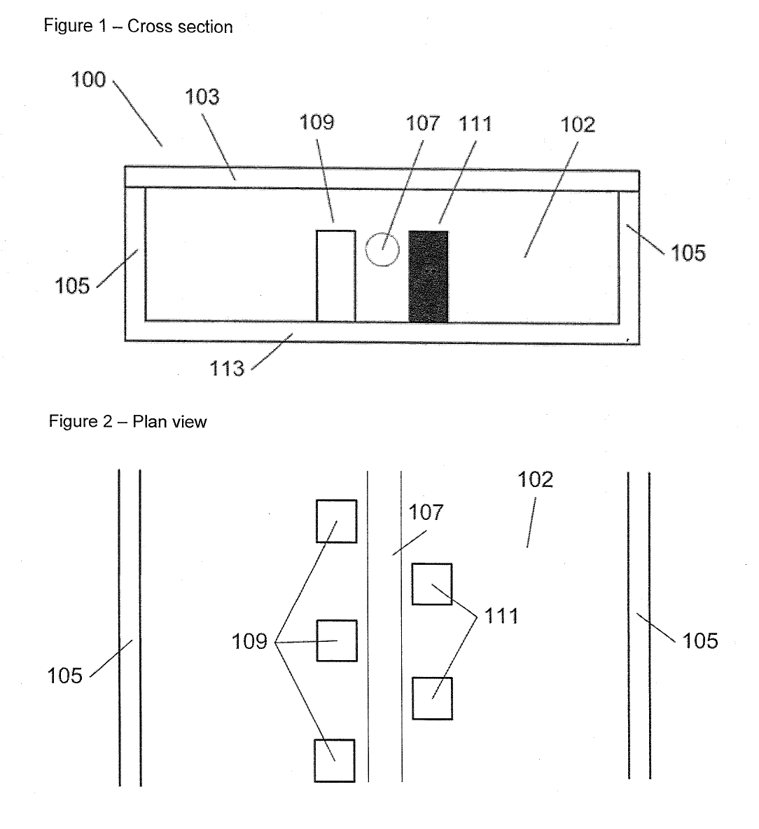

FIG. 1 shows a cross section of the operative part of an embodiment of the present invention. The figure is not to scale.

FIG. 2 shows a plan view of the operative part of an embodiment of the present invention. The figure is not to scale.

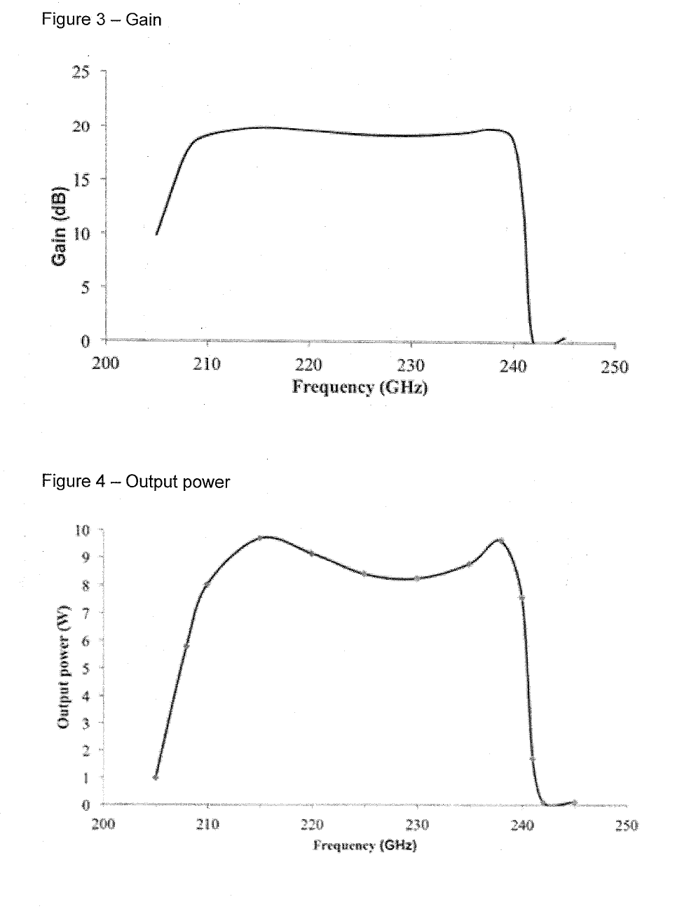

FIG. 3 shows a chart of the gain of one embodiment of the present invention

FIG. 4 shows a chart of the output power of one embodiment of the present invention

FIG. 1 shows a cross section of the operative part of an embodiment of the present invention (100). This (100) comprises a waveguide (102) of rectangular section, comprising a first part with a base (113) and two walls (105); and a lid (103).

The lid (103) may be a separate component for ease of manufacture, disassembly and reassembly. The lid (103) may be substantially planar (as shown in FIG. 1) or may have a rebate (or “rabbet”) (not shown) round its lower edge to aid location.

Within the waveguide (102) are two rows of pillars (109, 111) attached to the base (113) but not extending to the lid (103), so that there is a void between the top of each pillar (109, 111) and the lid (103).

The design of the present invention minimises field strength where the lid (103) and walls (105) meet, reducing the criticality of the joint.

The two rows of pillars (109, 111) are provided alternately. In FIG. 1 the right hand pillar (111) is filled black to indicate this. An electron beam (107) of substantially circular cross-section passes between the rows of pillars (109, 111). The present invention supports a cylindrical electron beam (107), which is straightforward to generate (for example by well-established Pierce electron guns) and to focus.

FIG. 2 shows a plan view of the operative part of an embodiment of the present invention. The two rows of pillars (109, 111) are provided alternately, and the electron beam (107) passes between the two rows of pillars (109, 111).

The pillars (109, 111) are not attached to the walls (105).

At each end of the operative section, coupling sections are provided (not shown) as is well known in the art, to allow entry and exit of the electromagnetic wave. Amplification is achieved by interaction of the electromagnetic wave and the electron beam (107) via the geometry of the waveguide (102) and the pillars (109,111). The present invention may also be used as an oscillator in the well known manner, by providing a coupling section (wave output; not shown) at one end only and providing no input signal.

In the embodiment shown in FIG. 2, the pillars (109, 111) are shown with rectangular cross-section. The pillars (109, 111) may be of any suitable cross-section, for example square, rectangular, circular, elliptical, triangular, or any cross-section optimised for a particular embodiment.

Components of the device (100) may be manufactured in any material with good electrical conductivity, or any suitable substrate coated with a material with good electrical conductivity.

Suitable materials with good electrical conductivity include most metals for example aluminium, copper or gold.

Components of the device (100) may be made in silicon coated with a conducting metal, for example gold.

Components of the device (100) may be made in double silicon-on-insulator (a silicon layer coated with gold).

Components of the device (100) may be made by additive or subtractive techniques.

In operation the device (100) is evacuated. The relative lack of internal structure in the present invention assists this function.

One specific embodiment is discussed in detail below to illustrate the design principles. It is well known to those skilled in the art how to adapt this to other requirements by variation. This device (100) may be tailored for operation at a range of frequencies in the band 10 GHz to 2,000 GHz.

In this embodiment the device is designed for amplification in the 200 to 250 GHz frequency band. The dimensions of the device are as follows:

Internal width=1260 microns

Internal height=395 microns

Pillar height=225 microns

Pillar width, length=80 microns

Pillar intra-row longitudinal stepping=348 microns

Pillar longitudinal separation (one row (109) to other row (111))=94 microns

Pillar transverse spacing=150 microns

Electron beam centre, below pillar top=25 microns

Electron beam radius=65 microns

Electron beam energy=13 keV

In this embodiment the number of pillars (109, 111) is one hundred and ten and the input wave power is 100 milliwatts. The electron beam voltage is about 13 kilovolts, the beam current is about 20 milliamps and the beam radius is 65 microns (giving beam power of about 260 watts and current density of about 150 Acm⁻²).

FIG. 3 shows the gain as a function of the frequency. Gain is close to 20 dB across the frequency band 210 to 240 GHz.

FIG. 4 shows the output power as a function of the frequency. Output power approaching 10 watts is obtained across the same frequency band.

The lower and the upper cut-off frequencies depend on the internal width of the waveguide (102) and the height of the pillars (109,111) respectively. The phase velocity is mainly determined by the longitudinal spacing of the pillars, the internal width of the waveguide (102) and the height of the pillars (109,111). It is well known to those skilled in the art how changing these physical dimensions allows the device to be tailored to give a range of electromagnetic properties, including operation at other frequencies, and operating as an amplifier or an oscillator.

While the present invention has been described in generic terms, those skilled in the art will recognise that the present invention is not limited to the cases described, but can be practised with modification and alteration within the scope of the appended claims. The Description and Figures are thus to be regarded as illustrative instead of limiting.

Where reference is made to numerical values, it is intended that a range from 10% less than the numerical value to 10% more than the numerical value is intended.

Throughout the description and claims of this specification, the words “comprise” and “contain” and variations of the words, for example “comprising” and “comprises”, mean “including but not limited to”, and are not intended to (and do not) exclude other components, integers or steps. All documents referred to herein are incorporated by reference.

Various modifications and variations of the described aspects of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes of carrying out the invention which are obvious to those skilled in the relevant fields are intended to be within the scope of the following claims.

1. A rectangular waveguide providing amplification of an electromagnetic wave via interaction with an electron beam in a channel, where:
the channel is confined above and below by the waveguide,
the channel is defined laterally by two parallel rows of alternately provided substantially identical pillars,
the pillars are attached substantially perpendicularly to a base of the waveguide, and
there is a void between a top of each pillar and a roof of the waveguide.

2. A waveguide as in claim 1 where the roof of the waveguide may be attached to complete manufacture and subsequently detached and re-attached.

3. A waveguide as in claim 1 where the pillars are not attached to walls of the waveguide.

4. A waveguide as in claim 1 operating in the 10 GHz to 2,000 GHz band.

5. A waveguide as in claim 1 operating in the 100 GHz to 1,000 GHz band.

6. A waveguide as in claim 1 operating in the 200 GHz to 650 GHz band.

7. A waveguide as in claim 1 operating in the 200 GHz to 250 GHz band.

8. A waveguide as in claim 1 where the pillars are substantially square or rectangular in section.

9. A waveguide as in claim 1 where the pillars are substantially circular or elliptical in section.

10. A waveguide as in claim 1 where the pillars are substantially triangular in section.

11. A waveguide as in claim 1 comprising metal components.

12. A waveguide as in claim 1 comprising components coated in metal.

13. A waveguide as in claim 1 operating in the 200 GHz to 250 GHz band, where the roof of the waveguide may be attached to complete manufacture and subsequently detached and re-attached.

14. A waveguide as in claim 1 operating in the 200 GHz to 250 GHz band, wherein where the pillars are not attached to walls of the waveguide.

15. A rectangular waveguide providing amplification of an electromagnetic wave via interaction with an electron beam in a channel, where:
the channel is confined above and below by the waveguide,
the channel is defined laterally by two parallel rows of alternately provided substantially identical pillars,
the pillars are attached substantially perpendicularly to a base of the waveguide, and
there is a void between a top of each pillar and a roof of the waveguide,
wherein
the pillars are not attached to walls of the waveguide, and
the roof of the waveguide may be attached to complete manufacture and subsequently detached and re-attached.

16. A waveguide as in claim 15 operating in the 10 GHz to 2,000 GHz band.

17. A waveguide as in claim 15 operating in the 100 GHz to 1,000 GHz band.

18. A waveguide as in claim 15 operating in the 200 GHz to 650 GHz band.

19. A waveguide as in claim 15 operating in the 200 GHz to 250 GHz band

20. A waveguide as in claim 15, where the pillars are substantially square or rectangular, substantially circular or elliptical, or substantially triangular in section.
